(19) United States
(12) Patent Application Publication
(10) Pub. No.: US 2006/0184295 A1
(43) Pub. Date: Aug. 17, 2006

(54) On-board datalogger apparatus and service methods for use with vehicles

(76) Inventors: Steve Hawkins, Ontario (CA); Jeff Ehlers, Neenah, WI (US); Michele Marvin, Cary, IL (US); Larry Welch, Fort Collins, CO (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/060,337

(22) Filed: Feb. 17, 2005

(51) Int. Cl. G06F 17/00

(52) U.S. Cl. 701/33; 701/35; 701/21

(57) ABSTRACT

On-board datalogger apparatus and service methods for use with vehicles are disclosed. A disclosed method of servicing a vehicle receives a non-volatile storage device containing vehicle data, couples the non-volatile storage device to a shared vehicle service system associated with a service facility, and conveys at least some of the vehicle data from the non-volatile storage device to the shared vehicle service system. The method also processes at least some of the vehicle data to generate corrective information configured to affect a repair of the vehicle, and stores the corrective information in the non-volatile storage device.

### FIELD OF THE DISCLOSURE

The present disclosure relates generally to vehicles and, more specifically, to on-board datalogger apparatus and related service methods for use with vehicles.

### BACKGROUND

Data collection devices for use with vehicles such as automobiles, trucks, and heavy machinery (e.g., construction equipment) are well known. Known data collection devices are typically configured to collect data (e.g., operational data such as engine data, transmission data, or other sub-system data) associated with a vehicle and, in some cases, to collect fault information related to vehicle operational problems. Many vehicles can be serviced by driving them to a service location at which a service technician connects a service tool to the vehicle to extract vehicle information (operational information or parameters, fault information, etc.) from a device on the vehicle. The service tool may be a relatively large, expensive, substantially non-portable unit that is capable of analyzing extracted data to diagnose a problem with the vehicle, recommend a repair strategy and/or a specific repair procedure, etc. Additionally, due to its expense, the service tool is often shared by a number of service technicians within a service facility and, in some cases, among multiple service facilities.

For some vehicles such as boats and other watercraft, the collection of vehicle data is complicated by the difficulty and/or expense associated with removing the craft from the water and transporting it to a service facility. Transport of such vehicles to a service facility typically involves over the road trailing or towing, which entails a significant amount of downtime, travel risks including damage to the vehicle and personal injury to the owner, expense, etc. Similarly, it may also be inconvenient, difficult and/or dangerous to drive or transport large vehicles such as recreational vehicles and heavy equipment (e.g., earth moving equipment, farm equipment, etc.) to a service facility.

In some cases, and particularly in the case of vehicles such as large watercraft and heavy equipment, a service technician may be dispatched to the location of the vehicle. The service technician may utilize a specialized portable battery powered service tool such as, for example, a laptop computer including specialized service software. Such a portable service tool may be coupled via a cable to a data collection system and/or a control module within the vehicle to extract operational data, fault data, etc. The technician may be able to utilize the specialized software within the service tool to analyze the extracted data to diagnose problems (e.g., failed or failing components) and determine an appropriate repair strategy or procedure.

The above-noted service tools and methods are disadvantageous in that they are expensive, may not be readily portable or may require an internal power source if they are portable, and are often designed or configured for use by trained technicians. Further, even if the above-noted service tools and methods could be operated by a typical vehicle owner, operator, or occupant, the above-noted service tools cannot be utilized quickly and easily to collect fault data and/or other operational information in temporal proximity to an operational problem, particularly during operation of (e.g., while driving) the vehicle. For example, a laptop computer is relatively bulky and expensive, may be easily damaged by liquid water or moisture, dirt and other contaminants, requires a significant amount of time to power up and become operational, and requires a significant amount of operator attention and effort to manipulate (e.g., keystrokes, cursor movements, etc.) to execute a data transfer from, for example, a data collection device within the vehicle to the laptop. Additionally, the above-noted service tools and methods, when used with vehicles such as watercraft and heavy equipment, may require service personnel to make multiple round trips to the location of the vehicle. An initial trip may be required to diagnose a problem (e.g., identifying a failing or failed component) and, following ordering and/or retrieval of needed repair components, a subsequent trip may be required to correct or repair the problem (e.g., install a new component). Such multiple trips entail a significant amount of downtime and expense.

Another common issue associated with vehicles, is the unavailability of a complete service history for a given vehicle. For example, a vehicle owner may not keep complete service records (or any service records) and may complicate matters by having the vehicle serviced at multiple service facilities. As a result, when the vehicle owner wishes to have the vehicle serviced by a particular service facility, that facility may not have access to the complete service history of the vehicle. Similarly, when the vehicle owner wishes to sell the vehicle to, for example, a dealership or another person, the vehicle owner may not be able to provide a complete and accurate service history of the vehicle to the potential purchaser because the records are distributed among many service facilities and/or do not exist.

### BRIEF DESCRIPTION OF THE DRAWINGS

FIG. 1 depicts an example data logging system within which the example service methods described herein may be implemented.

FIG. 2 is a more detailed block diagram of the example data logging system of FIG. 1.

FIG. 3 is a block diagram of an example service system including the example service facility of FIG. 1.

FIG. 4 depicts an example implementation of the portable data storage device of FIG. 2.

FIG. 5 depicts an example processor-based implementation of the example datalogger of FIG. 2.

FIG. 6 depicts a functional block diagram of an example implementation of the example datalogger of FIG. 2.

FIGS. 7-10 depict example implementations of the example user interface of FIG. 2.

FIG. 11 depicts an example implementation of the example storage device interface of FIG. 2.

FIG. 12 is a flow diagram of an example initialization process that may be carried out by the example data logging system and service center of FIG. 1.

FIG. 13 is a flow diagram of an example service call process that may be carried out by the example data logging system and service center of FIG. 1.

FIG. 14 is a flow diagram of an example implementation of the vehicle information processing process of FIG. 13.

FIG. 15 is a flow diagram of an example maintenance process that may be carried out by the example data logging system and the service center of FIG. 1.

### DETAILED DESCRIPTION

In general, the example datalogger apparatus and service methods described herein enable a vehicle owner or operator and/or a service technician to quickly and conveniently obtain vehicle information such as sub-system operational information, fault information, vehicle identification information, service or maintenance information, etc. from the vehicle and deliver that vehicle information to a service facility for analysis without having to transport the vehicle to the service facility. The analysis of the vehicle information at the service facility may identify a needed repair or adjustment, establish a service ticket for the vehicle, initiate the ordering of repair parts, initiate the scheduling of a convenient time at which the vehicle should be brought to the service facility for service, and/or may result in the generation of repair information, updated service or maintenance information, etc. to be delivered to a datalogger apparatus within the vehicle. As a result, service activities may be initiated and/or completed without having to transport the vehicle to the service facility, which may be inconvenient, difficult, and/or dangerous, particularly in the case of watercraft, heavy equipment and the like.

In one example implementation, the datalogger apparatus is mounted within or on a vehicle and is configured to communicate via a data port on the vehicle with a portable non-volatile data storage device such as, for example, a memory stick. Such portable non-volatile data storage devices are well known and are often implemented using a solid state memory technology such as flash memory. However, any other suitable data storage technology could be used to accomplish similar or identical results. In this manner, a vehicle owner or operator and/or a service technician can extract information from and deliver information to the datalogger apparatus without having to utilize expensive, relatively bulky and heavy specialized battery powered equipment such as a laptop computer. Nor does the vehicle owner or operator have to be skilled in utilizing specialized service-oriented software or the like. Additionally, the data storage device used in this example implementation does not require its own power source, is compact and lightweight, and can be easily made to withstand a variety of environmental conditions such as moisture, liquid water, vibration, shock, dirt, etc.

Continuing with the example implementation above, information extracted from the datalogger apparatus and stored within the non-volatile data storage device is delivered or otherwise communicated to a service facility such as, for example, a vehicle dealership. A service technician at the service facility may use a computer system to analyze the extracted information to identify repair and/or maintenance needed by the vehicle. In response to identification of the repair and/or maintenance needed by the vehicle, the service technician may order needed components and/or schedule a time for the vehicle to be delivered to the service facility for service based on availability of the needed components, if any, and convenience to the vehicle owner.

In some cases, the technician and/or computer system used thereby may identify a software change or update that addresses a repair or maintenance needed by the vehicle. In that case, appropriate corrective information is stored in the portable non-volatile data storage device, which is then carried back to the location of the vehicle. The data storage device is then communicatively coupled to the datalogger apparatus and the corrective information is conveyed to the datalogger apparatus to affect the needed repair or maintenance. The corrective information may include upgraded firmware, firmware changes that adjust vehicle parameters to accommodate drift, wear, and/or any other change associated with vehicle sensors, actuators, motors, sub-systems, etc., the specific environment within which the vehicle operates (e.g., relatively cold or hot climates, high altitude, etc.), and/or a vehicle performance characteristic desired by the owner (e.g., load pulling capability, high speed operation, etc.) Thus, in the above-described cases, a repair and/or maintenance of the vehicle can be performed by the owner of the vehicle without having to transport the vehicle to a service facility (thereby precluding continued use of the vehicle for its intended purpose) and without having to utilize expensive, specialized equipment (e.g., a laptop computer including specialized service software) at the location of the vehicle.

The example datalogger apparatus described herein also enables and facilitates the creation and storage of a vehicle service or maintenance history within the vehicle. For example, the example datalogger apparatus, in one example, includes a listing of all service tickets associated with the vehicle. In this way, the vehicle can be more easily serviced using any one of a number of service facilities because any selected service facility can access the records for the vehicle via the datalogger apparatus within the vehicle. Additionally, when the vehicle owner wishes to sell the vehicle to, for example, a dealership or another person, the vehicle owner can provide a substantially complete and accurate service history of the vehicle to the potential purchaser. In some cases, the potential purchaser may wish to extract the information (e.g., the service or maintenance history) and store it in their portable data storage device and have that data subsequently analyzed at a service facility of their choosing for use in making a decision to purchase the vehicle.

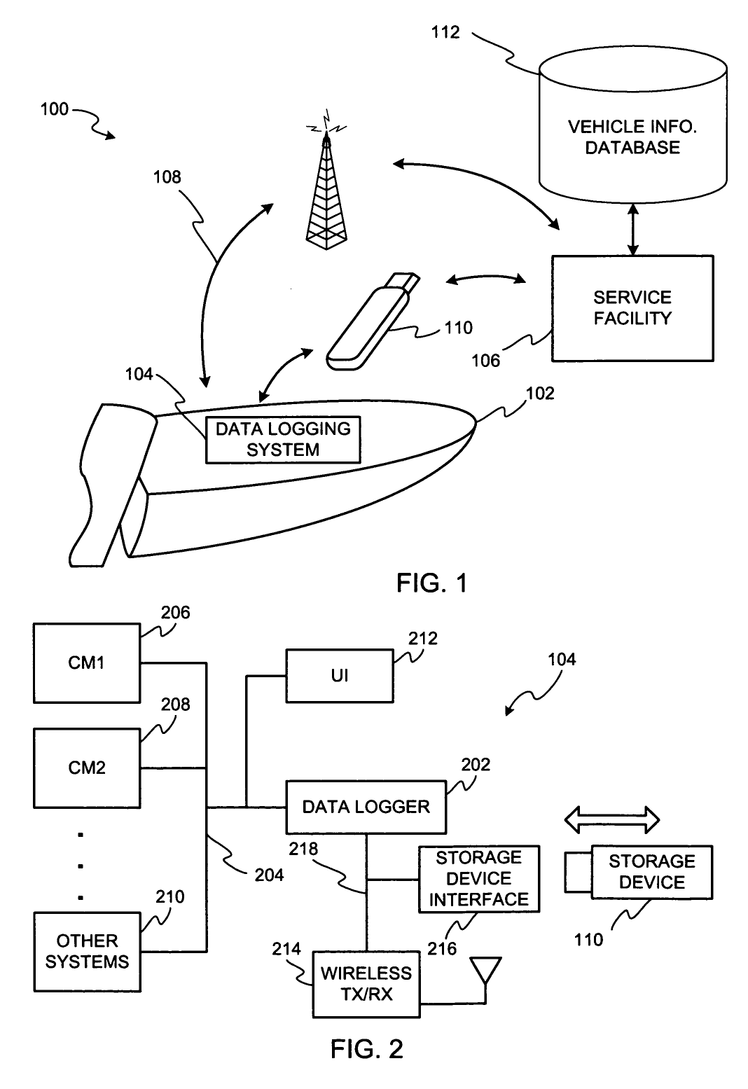

Now turning to FIG. 1, an example data logging system 100 within which the example service methods described herein may be implemented is shown. As depicted in the example system 100 of FIG. 1, a vehicle 102 having a data logging system 104 is configured to exchange information with a service facility 106 via a wireless communication link 108 and/or via a portable data storage device 110. As is also shown in FIG. 1, the service facility 106 is coupled to a vehicle information database 112, which contains vehicle information relating to a plurality of vehicles associated with one or more vehicle manufacturers and which may be exclusively accessed by the service facility 106 or, alternatively, may be accessed by a plurality of service facilities (not shown).

While the vehicle 102 is depicted as being a watercraft or boat, the vehicle 102 could instead by a truck, an automobile, a piece of heavy equipment (e.g., earth moving equipment), a recreational vehicle, or any other vehicle. However, the example datalogger apparatus and methods described herein are particularly advantageous in cases where it is inconvenient, costly, difficult, and/or dangerous to transport the vehicle 102 to the service facility 106.

As described in greater detail below, the example data logging system 104 is mounted within the vehicle 102 and is configured to record data associated with a plurality of sub-systems associated with the operation of the vehicle 102. More specifically, in the case where the sub-systems communicate via a data bus or network, the data logging system 104 also communicates via the data bus and monitors or records data bus or network communications or information, which may include vehicle operation information, fault information, etc. The example data logging system 104 is configured to selectively identify or segregate portions of the recorded information corresponding to certain events. For example, if the data logging system 104 identifies fault data or information present on the data bus, the data logging system 104 segregates or selects a portion of the recorded information corresponding to a first period of time preceding the time at which the fault data is recognized and a second period of time following the time at which the fault data is recognized. The segregated or selected portion of recorded information is then stored as an event for a possible subsequent analysis. As is also described in greater detail below, in addition to fault or event information, the example data logging system 104 stores maintenance or service history information associated with the vehicle 102, maintenance intervals or upcoming maintenance notifications, and/or vehicle operational or repair instructions.

The service facility 106, which may be a vehicle dealer or the like, is configured to receive vehicle information (e.g., fault or event information, vehicle identification information, vehicle operational information, etc.) from the data logging system 104 via the wireless communication link 108 and/or the portable data storage device 110. Regardless of the manner by which the service facility 106 receives the vehicle information from the data logging system 104, the service facility 106 is configured to analyze the vehicle information to identify any corrective information needed by the vehicle 102. For example, a technician at the service facility 106 can initiate a fault analysis of the vehicle information provided via the link 108 and/or the device 110. Such a fault analysis may compare the vehicle information associated with the vehicle 102 to vehicle information in the database 112. The comparison may match certain faults or fault codes with appropriate repair, maintenance, firmware upgrade, parameter value change(s), and/or other corrective information contained with the database 112. If needed, some or all of the corrective information can then be conveyed to the data logging system 104 via the link 108 and/or the portable data storage device 110 to affect a repair or maintenance of the vehicle. In other instances, some or all of the corrective information may be used to initiate a service ticket, order needed repair or maintenance parts, convey a message or notification (e.g., textual and/or graphical) to a user and/or schedule a convenient time at which the vehicle 102 should be delivered to the service facility 106 to complete the repair or maintenance.

FIG. 2 is a more detailed block diagram of the example data logging system 104 of FIG. 1. As shown in FIG. 2, the example data logging system 104 includes a datalogger 202 that is communicatively coupled via a communication network 204 to a plurality of control modules 206 and 208 and other systems 210 within the vehicle 102 (FIG. 1). The communication network 204 may be implemented using a controller area network (CAN) or any other suitable hardwired (e.g., via a harness with connectors) or wireless (e.g., Bluetooth) bus or network. The control modules 206 and 208 correspond to, for example, propulsion or engine control modules, vehicle control modules, etc. and the other systems 210 correspond to other systems or sub-systems distributed throughout the vehicle 102. For example, in the case where the vehicle 102 is a boat, the other systems 210 may include a generator sub-system, a navigational equipment sub-system, a lighting sub-system, etc.

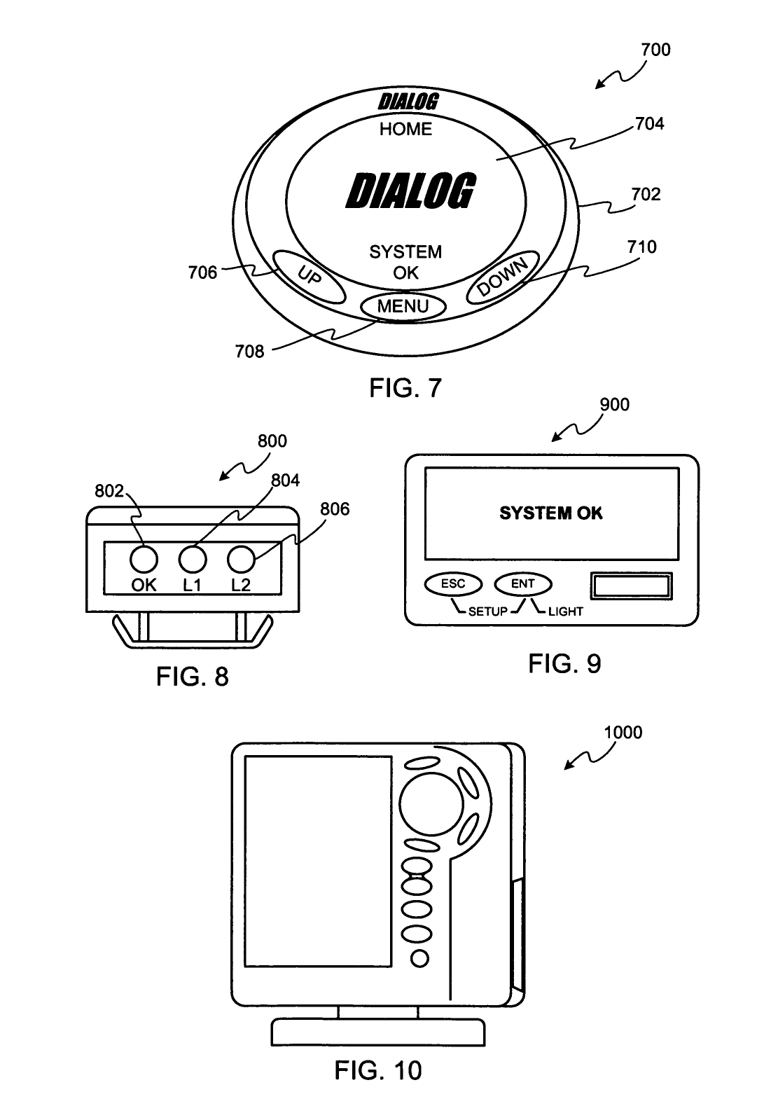

The datalogger 202 is also communicatively coupled to a user interface 212 via the network 204 or via a separate communication path (not shown). As described in greater detail in connection with FIGS. 7-10 below, the user interface 212 can be configured to provide a visual display of some or all of the vehicle information stored within the datalogger 202. For example, fault information, maintenance notifications, repair or operational instructions, service or maintenance history information, operational information, etc. can be displayed to a vehicle owner or operator and/or a service technician. The user interface 212 can also be configured to include one or more input devices such as buttons, switches, and the like to enable a user to navigate through available vehicle information, request or initiate data transfer activities, perform maintenance activities, etc.

The datalogger 202 is also coupled to a wireless transceiver 214 and a storage device interface 216 via a network or bus 218. The wireless transceiver 214 enables communications between the data logging system 104 and the service facility 106 via wireless the communication link 108. The wireless transceiver 214 can be implemented using any desired wireless communication platform and/or protocol. For example, a cellular-based communication platform and/or protocol could be used to provide coverage over a relatively large geographic area without having to invest in additional communications infrastructure. In other words, existing cellular communications infrastructure could be used to implement part of or substantially the entire communication link 108.

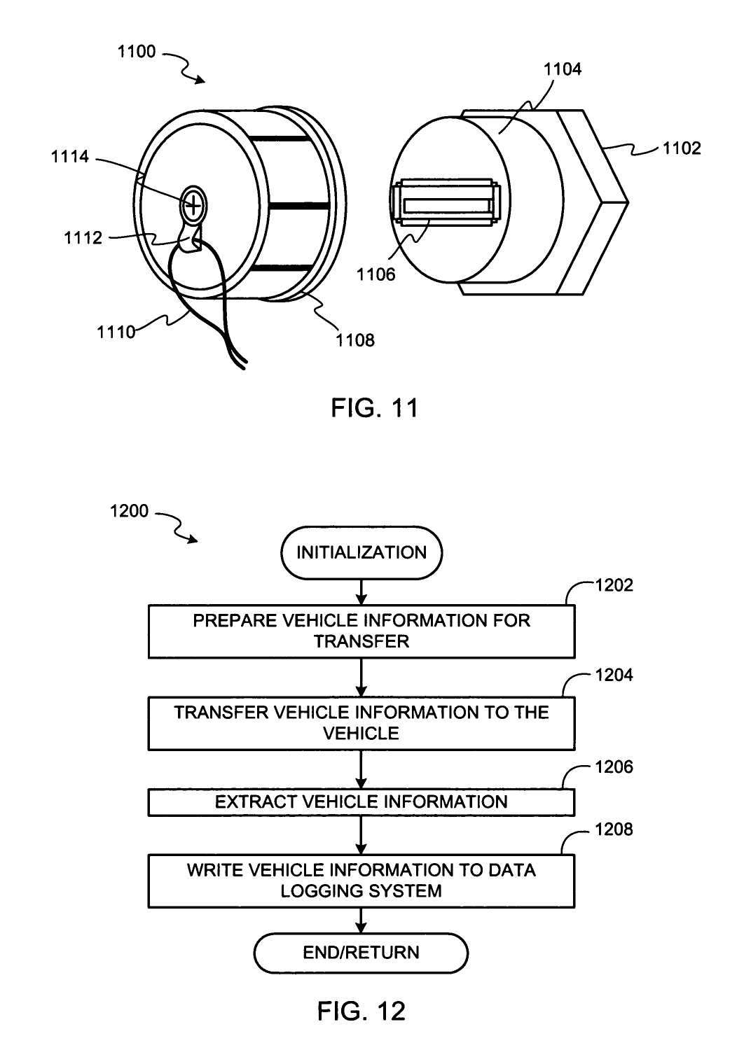

The storage device interface 216 is configured to receive the portable data storage device 110 to enable the exchange of data between the datalogger 202 and the storage device 110. In one example, the bus 218 complies with a universal serial bus (USB) standard and the storage device interface 216 includes a USB connector configured to receive a mating USB connector integral with the portable data storage device 110. In this case, the data logger 202 is configured to perform communication protocol conversions to enable some or all of the data conveyed via the bus 218 to be conveyed via the bus 204. In particular, the data logger 202 is configured to convey data via and between a USB protocol and a controller area network (CAN) protocol. An example implementation of the storage device interface 216 is shown and described in greater detail in connection with FIG. 11 below. Additionally, an example implementation of the portable data storage device 110 may be a memory stick device as described in greater detail in connection with FIG. 4 below.

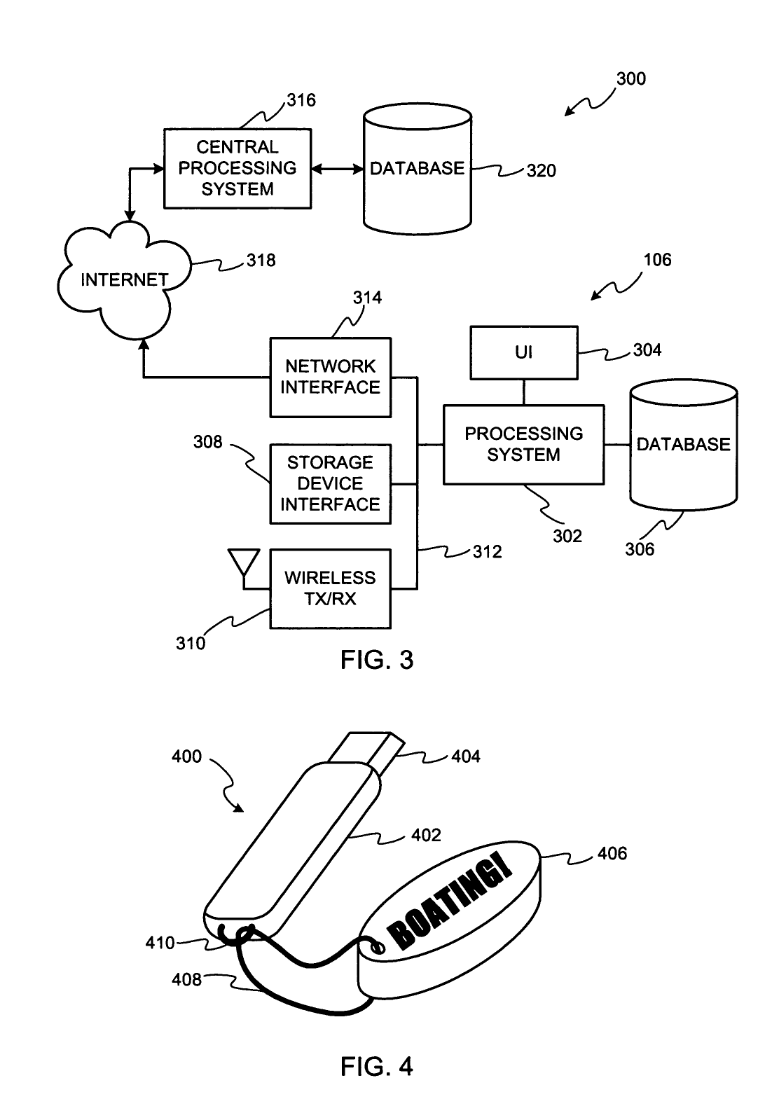

FIG. 3 is a block diagram of example service system 300 including the example service facility 106 of FIG. 1. The example service facility 106 includes a processing system 302 coupled to a user interface 304 and a database 306. The processing system 302 can be implemented using a computer such as a server or personal computer, or may be implemented using other combinations of hardware and/or software including application specific integrated circuits (ASICs), analog circuitry, digital circuitry, firmware, and/or high-level application software, etc. The user interface 304 can be implemented using one or more input and output devices including, for example, a keyboard, a keypad, a mouse, a video monitor, etc. The database 306 includes some or all of the vehicle information described in connection with the example database 112 (FIG. 1) and may be implemented using any desired mass storage media and hardware. For example, the database 306 may be a hard drive that uses optical and/or magnetic storage media.

The processing system 302 is also coupled to a storage device interface 308 and a wireless transceiver 310 via a bus or network 312. The storage device interface 308 is similar or identical to the storage device interface 216 described in connection with FIG. 2. However, the storage device interface 308 may not require or include certain features for preventing the ingress of environmental contaminants as may be required with the storage device interface 216 (FIG. 2) used on the vehicle 102 (FIG. 1). In other words, the storage device interface 308 may provide, for example, a USB compatible connector for receiving and communicating with the portable storage device 110 (FIGS. 1 and 2). Likewise, the wireless transceiver 310 may be similar or identical to the wireless transceiver 214 (FIG. 2) to enable communications via the communication link 108 (FIG. 1).

The processing system 302 may also be coupled to a network interface 314 via the bus or network 312 to enable the example service facility 106 (FIG. 1) to communicate with a central processing system 316 via, for example, the Internet 318. In one example, the central processing system 316 is operated by or otherwise associated with a vehicle manufacturer and functions as a centralized data collection and storage facility for use by a plurality of geographically distributed service facilities similar or identical in configuration to the example service facility 106 (FIG. 2). In this example, the central processing system 316 is coupled to a database 320 that contains aggregated vehicle information. Such aggregated vehicle information may include vehicle information associated with a plurality of different vehicles, repair or maintenance information provided by the vehicle manufacturer and/or one or more of the service facilities (e.g., the service facility 106), statistics related to or derived from the vehicle information, costs associated with certain repairs or maintenance activities, customer information, or any other vehicle information. Some or all of the information stored in the database 320 can be used by the processing system 302 and/or stored locally at the service facility 106 in the database 306 as needed. Additionally, the central processing system 316 could be communicatively coupled to the processing system 302 via a wide area network or any other network instead of or in addition to the Internet 318.

FIG. 4 depicts an example implementation 400 of the portable data storage device 110 of FIGS. 1 and 2. In general, the example portable data storage device 400 is a memory stick device (e.g., a flash memory device or other solid state non-volatile memory device) having a casing 402, which may be made of metal and/or plastic, a connector 404, which is depicted as being a USB compatible connector, and an optional floatation member 406. The flotation member 406 can be made of closed cell foam or other suitable material to enable the portable data storage device 400 to float if it is dropped into water. The floatation member 406 is coupled to the casing 402 via a tether 408 and a loop or eyelet 410 that is fixed to the casing 402. The casing 402 and the connector 404 may be configured to withstand outdoor environmental conditions including liquid water, high moisture, high and low anticipated outdoor temperatures, vibration, shock, etc. However, in other implementations, the portable data storage device 400 may not need to be made environmentally rugged owing to the environmental conditions associated with the particular application(s) in which the storage device is being used 400.

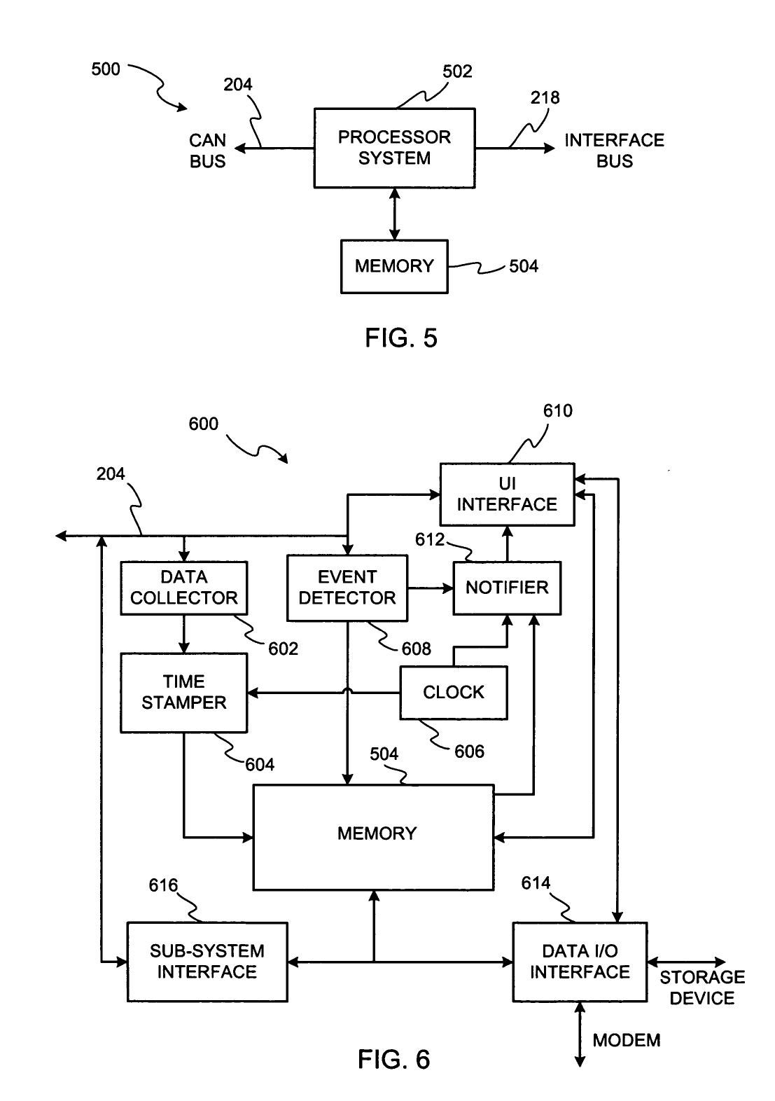

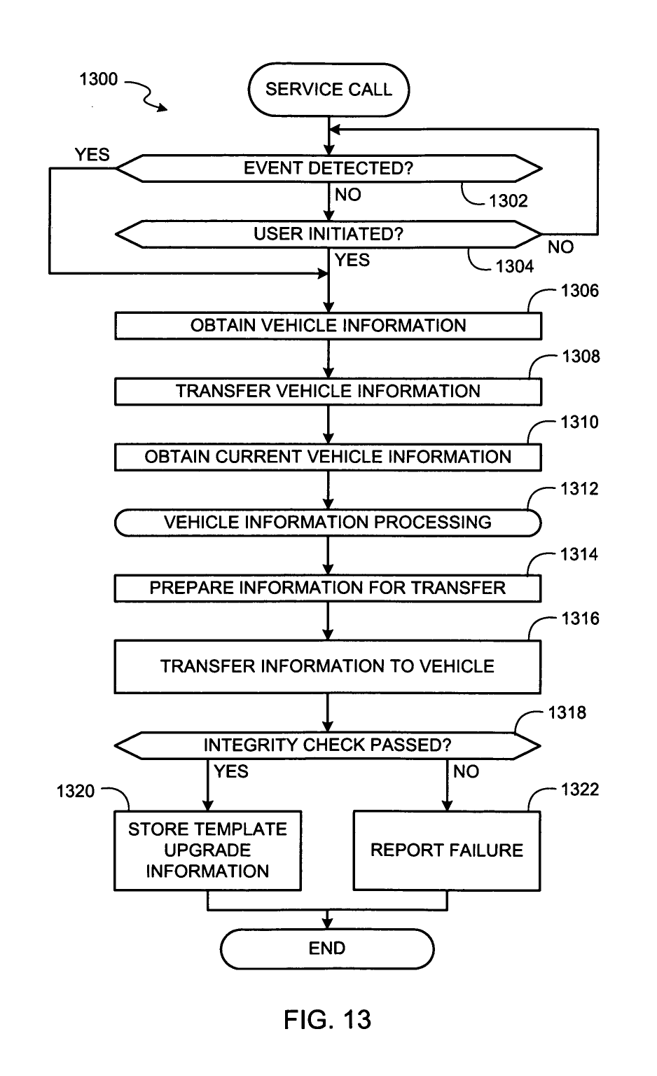

FIG. 5 depicts an example processor-based implementation 500 of the example datalogger 202 of FIG. 2. The example datalogger 500 of FIG. 5 includes a processor system 502 coupled to a memory 504. The processor system 502 is coupled to the network 204, which may be a CAN bus (e.g., a CAN 2.0b bus) as described in connection with FIG. 2 above. The processor system 502 is also coupled to the interface network or bus 218, which may be a USB compatible bus. The processor system 502 may be implemented using one or more microprocessors, microcontrollers, ASICs, analog circuitry, digital circuitry, etc. configured to perform the datalogger processes described herein and, particularly, the processes described in connection with FIGS. 12-15 below.

The memory 504 may include any desired combination of volatile and non-volatile memory including random access memory (RAM), read only memory (ROM), flash memory, electrically programmable read only memory (EPROM), electrically erasable programmable read only memory (EEPROM), mass storage memory including, for example, a hard drive configured to read and write to optical and/or magnetic media, etc. In one example, the memory 504 includes a relatively large amount of memory (e.g., more than one-hundred megabytes) to store vehicle information recorded from the network or bus 204 over a relatively long period of time (e.g., forty hours).

FIG. 6 depicts a functional block diagram of an example implementation 600 of the example datalogger 202 of FIG. 2. The example datalogger 600 includes a data collector 602, a time stamper 604, and the memory 504, all of which are coupled as shown. The data collector 602 is configured to periodically monitor communications on the network or bus 204 to extract or collect information related to the various sub-systems (e.g., the systems 206, 208, and 210 of FIG. 2) associated with the vehicle 102 (FIG. 1). The vehicle information collected by the data collector 602 includes vehicle operating parameters, conditions, etc., fault information, etc. The data collector 602 passes the collected vehicle information to the time stamper 604, which receives a time signal from a non-volatile clock 606, which may be a real-time clock, and time stamps the collected information prior to storing it in the memory 504. The memory 504 maintains a circular buffer for storing the information collected by the data collector 602. Such a buffer may utilize, for example, about fifty megabytes of the memory 504 and may, for example, enable the datalogger 600 to capture or monitor more than forty hours of communications on the bus 204. A second buffer for storing event information may also provide, for example, about fifty megabytes of storage capacity, may also be included within the memory 504 to store event information extracted from the first circular buffer. Thus, the datalogger 600 can separately store a relatively large amount of event information while allowing the first circular buffer to record in a substantially continuous manner.

The datalogger 600 also includes an event detector 608 that is configured to detect, for example, the occurrence of fault codes or other fault information or data on the bus 204. Upon the detection of an event (e.g., a fault code) on the bus 204, the event detector 608 marks or otherwise identifies collected data in the memory 504 corresponding to a period of time spanning a predetermined amount of time prior to the occurrence of the event (e.g., five minutes) to a predetermined amount of time following the occurrence of the event (e.g., fifteen minutes). Such event-related information may then be stored in the above-mentioned second buffer in the memory 504. Of course, other periods of time surrounding the detected event could be used instead. In addition to a period of time associated with each event, each event may be associated with a date and time, parameter information, etc. Further, in addition to or as an alternative to the use of timestamps, data stored in the memory 504 and corresponding to events may be composed of frames of data, where each frame corresponds to a predetermined number of bytes, a predetermined number of parameters, and a predetermined data rate or resolution.

The datalogger 600 also includes an interface 610 for communicating with the user interface 212 (FIG. 2). In general, the interface 610 enables the example datalogger 600 to receive inputs, commands, etc. from a user via the user interface 212 (FIG. 2). For example, a user may request maintenance information, operational status information, initiate or otherwise cause the transfer of vehicle data between the datalogger 600 and the portable storage device 110 (FIG. 1) and/or via the communication link 108 (FIG. 1), etc. via the user interface 212 (FIG. 2). Additionally, the datalogger 600 may use the interface 610 to send notifications, messages, alerts, warnings, or any other information to the user interface 212 automatically without requiring user input. For example, the example datalogger 600 may include a notifier 612 for sending information relating to certain events or conditions to the user interface 212 for presentation to a user via the user interface 212 (FIG. 2). In particular, the notifier 612 is coupled to the event detector 608 and receives signals from the event detector 608 indicative of the occurrence of events. In response to receipt of event information, the notifier 612 is configured to send information indicative of the event to the user interface 212 (FIG. 2) via the interface 610 and the bus 204. In this manner, the user may be presented with a visual and/or audible indication that an event (e.g., a fault) has occurred. As described in connection with FIGS. 7-10 below, such indications can include an alarm or alert sound, textual messages, graphical symbols, colored lights, etc. The notifier 612 may also be configured to monitor the clock 606 and maintenance information stored in the memory 504 to provide maintenance notifications to the user interface 212 via the interface 610. For example, the notifier 612 may generate a maintenance reminder notification after a predetermined number of vehicle operation hours and/or maintenance interval hours have elapsed.

Still further, the example datalogger 600 includes a data input/output (I/O) interface 614 for communicating via the data storage device interface 216 (FIG. 2) and/or the wireless transceiver 214 (FIG. 2). In particular, the data I/O interface 614 enables vehicle information to be extracted from the memory 504 and communicated to the service facility 106 (FIG. 1). Additionally, the data I/O interface 614 enables the results of analyses, updated service information, corrective information, etc. to be communicated from the service facility 106 (FIG. 1) to the datalogger 600 and, as needed, stored in the memory 504. The data I/O interface 614 is coupled to the data I/O interface 610 to enable a user to initiate and/or control the exchange of data between the datalogger 600 and the portable storage device 110 (FIG. 1) and/or the wireless communication link 108 (FIG. 1). Examples of such data exchanges are described in connection with FIGS. 12-15 below.

The datalogger 600 also includes a sub-system interface 616 to enable communications between the various sub-systems (e.g., the control modules 206 and 208, the other systems 210, etc.) within a vehicle (e.g., the vehicle 106 of FIG. 1) and the datalogger 600. In one example, the sub-system interface 616 conveys corrective information received via the data I/O interface 614 (e.g., via a USB device) and conveys that information to the appropriate sub-system(s) in a format compatible with the communication protocol used on the bus 204 (e.g., a CAN protocol). Similarly, the subsystem interface 616 is configured covey information stored in memory 504 to one or more sub-systems via the bus 204.

FIGS. 7-10 depict example implementations of the user interface 212 of FIG. 2. The example user interface 700 of FIG. 7 is configured to provide the appearance of a gauge used with marine vessels. As shown in FIG. 7, the example user interface 700 includes a case or bezel 702, a display area 704, and a plurality of buttons or switches 706, 708, and 710. The example user interface 700 displays textual and/or graphical messages, notifications or alerts, including maintenance notifications, faults, etc. Additionally, a user can, via the buttons 706-710, view any vehicle information stored in the memory 504 (FIG. 6) of the datalogger 600 (FIG. 6). For example, a user can view maintenance information such as detailed historical (e.g., closed service tickets) and current or open service ticket information, maintenance schedules, vehicle documentation, vehicle identification information, hours of operation since last maintenance or service, fault codes or other detailed fault information, etc. The display area 704 may be implemented using any desired display technology including, for example, a dot matrix-based liquid crystal display, a plasma display, etc.

FIG. 8 depicts another example user interface 800 having a plurality of light-emissive devices (e.g., light emitting diodes) 802, 804, and 806 that are configured to illuminate in response to certain predetermined conditions. For example, the light-emissive device 802 may be illuminated when there are no faults and operation of the various sub-systems of the vehicle 102 (FIG. 1) is normal. The other light-emissive devices 804 and 806 may be illuminated to indicate that maintenance is needed, a fault has occurred, a data transfer between the datalogger 600 (FIG. 6) and the service facility 106 (FIG. 1) is needed, has been completed, etc.

FIGS. 9 and 10 depict alternative user interface configurations 900 and 1000 that may be used to implement the user interface 212 (FIG. 2). The user interface configurations 900 and 1000 may be multi-purpose devices. For example, the example user interfaces 900 and 1000 may serve as electronic vehicle gauges, navigation units, fish finders, etc. as well as provide interface functionality for interfacing with the datalogger 600 (FIG. 6).

FIG. 11 depicts an example implementation 1100 of the storage device interface 216 of FIG. 2. The example data storage device interface 1100 includes a mounting base 1102 having a polygonal geometry to facilitate fixation of the base 1102 to the vehicle 106 (FIG. 1). For example, a wrench, pliers, etc. may be used to grip the flat portions of the polygonal base to facilitate the tightening or installation of the base 1102 into a threaded opening or threaded fastener. The base 1102 includes a cylindrical data port member 1104 that holds a data port connector 1106. In one example, the data port connector 1106 is a USB compatible connector configured to accommodate a memory stick having a mating USB connector. The example storage device interface 1100 also includes a cap or cover 1108 configured to be screwed or snapped over the cylindrical data port member 1104. An elastomeric seal such as an o-ring (not shown) may be used to provide improved environmental resistance to protect the connector 1106 from the ingress moisture, liquid water, dirt, and other contaminants. The cap or cover 1108 includes a tether 1110 that is fixed to the cap or cover 1108 via a loop 1112 and screw 1114. An end of the tether 1110 may be fastened to the base 1102 or in proximity to the base 1102 to prevent loss of the cap 1108 when removed from the base 1102.

Turning now to FIGS. 12-15, example processes that may be carried out in a cooperative manner by the example data logging system 104 and the example service facility 106 of FIG. 1 are shown. The processes shown may be implemented as software instructions stored in one or more computer readable media and executed by one or more processing units. Alternatively, one or more operations of the processes may be implemented in dedicated hardware or firmware. As a further alternative, one or more of the operations shown in FIGS. 12-15 may performed manually by one or more persons.

In general, the example processes of FIGS. 12-15 illustrate functionality that may be implemented to facilitate vehicle information exchange between the data logging system 104 (FIG. 1) and the service facility 106 (FIG. 1). As described in detail below, the vehicle information that is exchanged may include maintenance information (e.g., service tickets, service records, etc.), system information (e.g., fault codes, firmware/software updates and/or upgrades and/or corrective information, etc.), and/or messages (e.g., service related messages, error messages, etc.). As described above, such information may be exchanged using a portable data storage device such as a flash-based memory device and/or via one or more wired or wireless networks.

An example initialization process 1200 as shown in FIG. 12 may be carried out to initialize a data logging system (e.g., the data logging system 104 of FIG. 1) in a vehicle for operation. In one particular example, the initialization process 1200 may be carried out when a vehicle is purchased from a dealer. During operation, the initialization process 1200 prepares vehicle information for transfer (block 1202). Preparing vehicle information includes operations or activities at a service facility that are performed by a dealer or service technician who gathers information including the on-board data logging system to be initialized. The vehicle information can include a vehicle information number (VIN); a hull identification (Hull ID); the identity of the vehicle owner; the date on which the vehicle was purchased; the systems configuration of the vehicle; device make, model and serial numbers for system components (e.g., engine, transmission, generator, etc.), etc. In one example, the systems configuration may include a listing of modules that are coupled to the data logging system, some examples of which are provided above. Additionally, the vehicle information may include a fault listing, such as a fault database that lists the fault codes for various components within the system. Further, because the system includes a number of sensors, the normal operating range of each of the sensors may be gathered. In addition, the latest firmware for the datalogger may be obtained and prepared for transfer.

Preparing the vehicle information for transfer may include compression or encryption of the vehicle information. In one example, to reduce the size of the vehicle information to be transferred, the vehicle information may be compressed or “zipped” into a file format having a relatively small size (i.e., relatively small memory capacity usage). In some situations, the compressed file may also be encrypted to protect the vehicle information from being viewed by unauthorized entities. The encryption may be carried out using an encryption key that may be related to the vehicle or is otherwise known by the recipient of the vehicle information. For example, an encryption key may be selected to match the VIN or Hull ID of the vehicle so that the vehicle information is only useful to entities knowing such information about the vehicle to which the vehicle information corresponds. Of course, encryption and compression need not be used together. Thus, in some situations vehicle information may be compressed and encrypted, while in other situations the vehicle information may be compressed or encrypted, but not both. As a further alternative, the vehicle information need not be compressed or encrypted at all and may be transferred in an uncompressed and encryption-free manner. When the vehicle information is prepared for transfer, the vehicle information may be referred to as “packed.”

After the vehicle information is prepared for transfer (block 1202), the vehicle information is transferred to the vehicle (block 1204). In general, this transfer may be carried out in a number of different ways including the use of one or more of a memory device, a wireless connection, a cable connection, a network, etc. In one example, the information may be uploaded to a memory device, such as a portable data storage device (e.g., the portable data storage device 110 of FIG. 1), and the portable data storage device may be physically transferred to the vehicle. Alternatively, the vehicle information may be electronically transferred to the vehicle such as, for example, via electronic mailing of the information to a person who retrieves the electronic mail having the vehicle information attached thereto and then transfers the vehicle information to the vehicle using a cable, the Internet, wireless, a portable data storage device, or any other suitable technique. As a further example, the vehicle information may be transferred to the vehicle using a wireless connection (e.g., the link 108 of FIG. 1) from the service facility (e.g., the service facility 106 of FIG. 1).

After the vehicle information has been transferred, or while the transfer is in process, the data logging system extracts the vehicle information (block 1206). The extraction process may be very simple or very complex and, in general, processes the received vehicle information in a manner that “unpacks” the vehicle information that was “packed” when the vehicle information was prepared for transfer (block 1202). As described above, the vehicle information may be encrypted using a key associated with a vehicle (e.g., VIN or Hull ID) or may not be encrypted. Additionally, as noted above with respect to block 1202, the vehicle information may be compressed or uncompressed. In any event, the extraction at block 1206 prepares the vehicle information for use by the data logging system.

After the vehicle information is extracted, the vehicle information is written to the data logging system (block 1208). In one example, the vehicle information is written to particular memory addresses within the data logging system memory. At the completion of the initialization process 1200, the datalogger of the vehicle is initialized with vehicle information.

A service call process 1300 may be carried out by the example data logging system 104 and the example service facility 106 of FIG. 1. In general, after initiation, the service call process 1300 transfers vehicle information between the data logging system 104 and the service facility 106 to effectuate changes within the data logging system 104. As described in detail below, the vehicle information may include firmware upgrades, database upgrades, fault conditions, corrective data, diagnostic data, vehicle status data, historical data, maintenance data, service tickets, etc.

The service call process 1300 begins with the data logging system (e.g., the data logging system 104 of FIG. 1) determining if a specific condition or event is detected (block 1302). This functionality may be carried out by a processor-based system (e.g., the processor system 502 of FIG. 5 and/or the event detector 608 of FIG. 6) that is coupled to a bus, such as the bus 204, and which monitors bus communications to determine if certain conditions or events have occurred. For example, the data logging system 104 may monitor the bus 204 for the occurrence of a fault code, such as may be generated by one or more different system components (e.g., the control modules 206 and 208 and/or the other systems 210).

If a predefined condition or event has not occurred (block 1302), the process 1300 determines if the user has provided an input indicating that vehicle information is to be exchanged. This may be carried out using interrupt processing, etc. A user input may include a user requesting database, service, and/or maintenance upgrades. For example, a user may notice that the vehicle is not operating properly (e.g., the vehicle is running rough, etc.) and may initiate a sequence causing vehicle data to be obtained and sent to a service facility for diagnosis. If no user input is detected and no condition or event is detected, the process 1300 continues to monitor for conditions or events and user inputs.

However, if either a condition or event is detected (block 1302) or a user has initiated a service process (block 1304), the process 1300 obtains the vehicle information (block 1306). Obtaining the vehicle information may be carried out by a processor (e.g., the processor system 502 of FIG. 5) that is coupled to a memory (e.g., the memory 504 of FIG. 5). The information that is obtained may include historical data, system events, vehicle characteristics (e.g., VIN, Hull ID, serial numbers, model numbers, etc.), customer information, datalogger firmware and/or software versions, data tables, etc. For example, in response to a user indicating that the vehicle is not operating properly, the process 1300 retrieves data from the memory and prepares the same for transfer.

Alternatively, if a condition or event is detected (e.g., a fault event), the vehicle information that is obtained may include data associated with a time period prior to the condition or event and data associated with a time period after the condition or event. For example, upon receiving an indication of a fault event, vehicle information five minutes prior to the fault and ten minutes after the fault may be obtained. Additionally, an event or condition may be compared to a text table to enable the datalogger to provide a message to a vehicle user to inform the user of vehicle status. For example, if a serious fault has occurred, in addition to obtaining the data related to the fault, the user may receive a message (e.g., via the user interface 212 of FIG. 2) that the vehicle needs service, or that the vehicle should not be operated further, or may be operated further but only within specific parameters.

Once the vehicle information is obtained (block 1306), the vehicle information is transferred (block 1308). As noted above with respect to the initialization process 1200, vehicle information may be transferred using any number of different media. For example, the information may be transferred using one or more of a portable data storage device (e.g., a memory stick), a network (e.g., the Internet), a wireless system, etc.

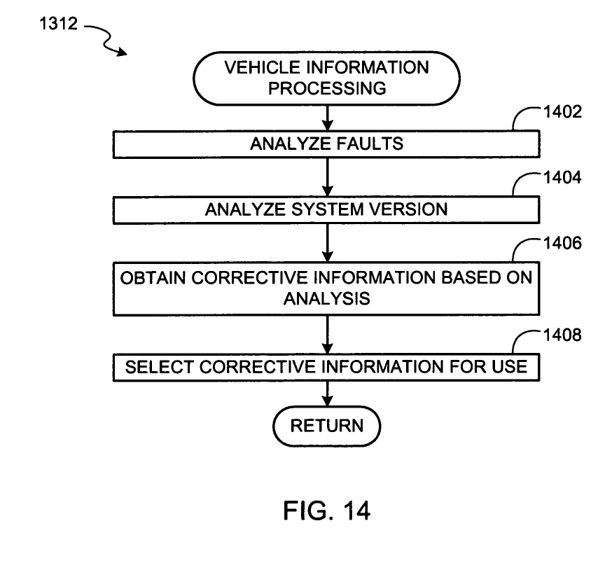

The service facility then obtains the vehicle information (block 1310) by receiving the information that was transferred (block 1308) and initiates a vehicle information processing process 1312, which is described in further detail in conjunction with FIG. 14. As shown in FIG. 14, the process 1312 begins by analyzing faults indicated in the vehicle information (block 1402). The fault analysis may be carried out using any troubleshooting techniques. For example, a service facility or a dealer may maintain and/or may have access to (e.g., the central processing system 316 of FIG. 3) a log or database of faults and corresponding system corrective information (e.g., software or firmware changes, etc.) for alleviating or addressing those faults.

The process 1312 also analyzes the system version of the firmware and/or software being executed (block 1404). For example, the system version executed by the data monitor may be compared to the latest system version to determine if a firmware and/or software upgrade is needed.

After the analysis is complete (blocks 1402 and 1404), corrective data is obtained (block 1406). The corrective information may include data that changes the operational parameters of system components, upgraded software/firmware, messages, etc. For example, if the fault analysis (block 1402) reveals that a software change is needed to rectify an operational aspect of the vehicle, the software change may be generated or obtained. Alternatively, if the fault requires replacement of system components, an appropriate message indicative of that required replacement is sent to the vehicle.

As noted above, the process 1312 may be carried out at the service facility (e.g., the service facility 106). Accordingly, the corrective information may be displayed to a user (e.g., a service technician) after it has been obtained (block 1406). The user may then select the corrective information to be used (block 1408). For example, based on the analysis (blocks 1402 and 1404), the user may be presented with a number of pieces of corrective information (e.g., a software upgrade, a firmware patch, a message to the vehicle owner to bring the vehicle in for service, etc.) The user may then select one or more of the pieces of corrective information to be used (block 1408). For example, a user may select the software upgrade and the firmware patch to be sent and may opt to not send the message. The selection may be carried out using checkboxes or any other suitable user interface technique that enables a user to select one or more pieces of information. After the corrective data for use has been selected, the process 1312 ends and control returns to the service call process 1300.

The service call process 1300 continues by preparing the information for transfer (block 1314). As noted above, preparation for transfer may include compression and/or encryption of the corrective information. The corrective information is then transferred to the vehicle (block 1316). As noted above, information transfer may include physical transfer of the information via a hardware device (e.g., a memory stick) and/or transfer via wired and/or wireless transfer.

After the information is transferred (block 1316), the information is subjected to an integrity check (block 1318). The integrity check may be performed by the data logging system and may include any procedure for ensuring the integrity of the data that is received at the data logging system. For example, the integrity check may include performing a checksum determination on received information, ensuring that a VIN or Hull ID in the received information matches a VIN or hull ID known by the data logging system to be associated with the vehicle. The integrity check may be carried out as part of a decryption process wherein the Hull ID or VIN number is used as a key to decrypt the information. If the decryption fails when using that hull ID or VIN, the data logging system recognizes that the information was not properly formatted for use by the data logging system and, thus, the information is not authentic.

If the integrity is verified, the information is implemented within the datalogger (block 1320). Implementation may include changing the contents of one or more addresses in the datalogger memory and/or displaying a message to the user. Alternatively, if the information integrity check is not passed, the failure is reported to the user via, for example, the user interface located within the vehicle (e.g., the user interface 212) (block 1322).

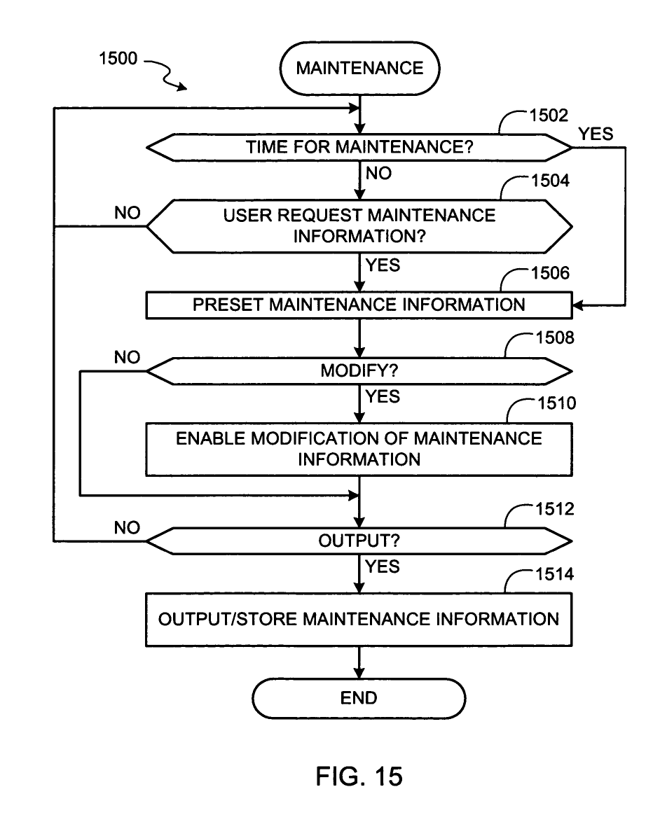

As noted above, the data logging system may be configured to facilitate the tracking of maintenance performed on the vehicle, as well as providing reminders that vehicle maintenance is required. Turning to FIG. 15, a maintenance process 1500, which may be performed by the data logging system, determines if it is time for maintenance to be performed (block 1502) on the vehicle. The determination that maintenance is required may be based on the number of hours the vehicle has been in service, the number of miles traveled by the vehicle, the time that has elapsed since the last service, etc.

If it is not time for maintenance, the process 1500 determines if a user has made a request for maintenance information (block 1504). If the user has not requested maintenance information, the process 1500 continues to wait for a time when maintenance is due and/or when a user has requested maintenance information. If either the time for maintenance has arrived or the user has requested maintenance information, the process 1500 presents maintenance information to the user (block 1506). The presentation of maintenance information may be carried out via a user interface device such as a display screen.

When the maintenance information is displayed (block 1506), the user may be prompted to modify the maintenance information (block 1508). If modification is desired, modifications may be made to the maintenance information (block 1510). For example, maintenance information may be updated after a user has performed a particular maintenance task such as changing the vehicle oil, changing sparkplugs, cleaning fuel injectors, etc. Of course, the maintenance information may be modified by a vehicle owner, a service technician, or any other authorized person. The modification of the maintenance information may be carried out through a series of user interface prompts, checkboxes, etc., that a user may navigate to input the subject maintenance information. For example, a maintenance portion of the user interface may include graphics indicating that an oil change is due, but not yet performed. Upon completing the oil change a user may navigate to the maintenance portion of the user interface to indicate that the maintenance was performed by, for example, placing a graphical check in a maintenance checkbox.

After the maintenance information is modified (block 1510) or if such a modification is not required or desired, the user is prompted to output the maintenance information (block 1512). If the maintenance information is not to be output, the process 1500 restarts. However, if the maintenance information is to be output, the maintenance information is stored/output (block 1514). The maintenance information may be output to any storage media such as memory, paper, a computer memory, a hard drive, flash memory, etc. Alternatively, the maintenance information may be output via a wired or wireless connection to one or more different destinations. For example, the maintenance information may be output to a service facility to synchronize the maintenance records of the service facility with the maintenance records stored local to the vehicle in the datalogger.

As a further alternative, rather than the modification of the maintenance information being carried out through the user interface of the data logging system, the maintenance records may be modified using a different platform. For example, the entire maintenance record could be downloaded to a host (e.g., a computer) where the maintenance records could be modified and uploaded back to the data logging system.

Although certain apparatus, methods, and articles of manufacture have been described herein, the scope of coverage of this patent is not limited thereto. To the contrary, this patent covers all apparatus, methods, and articles of manufacture fairly falling within the scope of the appended claims either literally or under the doctrine of equivalents.

What is claimed is:

1. A method of servicing a vehicle, comprising:
receiving a non-volatile storage device containing vehicle data, wherein the non-volatile storage device does not require an internal power source to perform storage operations;
coupling the non-volatile storage device to a shared vehicle service system associated with a service facility;
conveying at least some of the vehicle data from the non-volatile storage device to the shared vehicle service system;
processing the at least some of the vehicle data to generate corrective information configured to affect a repair of the vehicle; and
storing the corrective information in the non-volatile storage device.

2. A method as defined in claim 1, further comprising:
coupling the non-volatile storage device to a data port on the vehicle; and
conveying the corrective information to a processing system on the vehicle to affect the repair of the vehicle.

3. A method as defined in claim 2, wherein conveying the corrective information to the processing system on the vehicle comprises receiving an input from a user via a user interface on the vehicle.

4. A method as defined in claim 2, wherein the data port is configured to receive a universal serial data bus connector on the non-volatile storage device.

5. A method as defined in claim 1, wherein conveying the at least some of the vehicle data from the non-volatile storage device to the shared vehicle service system comprises coupling the non-volatile storage device to a data port of the shared vehicle service system.

6. A method as defined in claim 1, wherein the vehicle is a marine vessel, heavy equipment, or a recreational vehicle.

7. A method as defined in claim 1, wherein the non-volatile storage device is a memory stick.

8. A method as defined in claim 1, wherein processing the at least some of the vehicle data to generate the corrective information comprises comparing the at least some of the vehicle data to vehicle data stored in a central processing system coupled to the shared vehicle service system via a network.

9. A method as defined in claim 1, wherein the vehicle data comprises a least one service ticket associated with the vehicle, fault information associated with the vehicle, or parameter value information associated with at least one sub-system of the vehicle.

10. A method of servicing a vehicle, comprising:
conveying vehicle data associated with the vehicle to a service facility remote from the vehicle;
processing at least some of the vehicle data at the service facility to generate corrective information configured to affect a repair of the vehicle; and
conveying the corrective information to the vehicle to affect the repair of the vehicle.

11. A method as defined in claim 10, wherein conveying the vehicle data associated with the vehicle to the service facility comprises storing the vehicle data on a non-volatile memory device at the vehicle and coupling the non-volatile memory device to a data port remote from the vehicle to convey the vehicle data.

12. A method as defined in claim 11, wherein coupling the non-volatile memory device to the data port remote from the vehicle comprises coupling the non-volatile memory device to a computer system remote from the vehicle and the service facility and conveying the vehicle data from the computer system to the service facility via a network connection.

13. A method as defined in claim 11, wherein coupling the non-volatile memory device to the data port remote from the vehicle comprises coupling the non-volatile memory device to a data port at the service facility.

14. A method as defined in claim 10, wherein processing the at least some of the vehicle data at the service facility to generate the corrective information comprises obtaining information from a central processing system via a network connection to the service facility.

15. A method as defined in claim 10, wherein the corrective information comprises at least one of service ticket information, updated firmware, or parameter value change information.

16. A method as defined in claim 10, wherein conveying the corrective information to the vehicle to affect the repair of the vehicle comprises storing the corrective information in a non-volatile memory device, transporting the non-volatile memory device to a location of the vehicle, and coupling the non-volatile memory device to a data port on the vehicle.

17. A method as defined in claim 16, further comprising receiving an input from a user via a user interface to cause the non-volatile memory device to transfer the corrective information to at least one of a datalogger or a control sub-system on the vehicle.

18. An apparatus for servicing a vehicle, comprising:
a data port configured to be fixed to the vehicle and to receive a non-volatile data storage device; and
a datalogger configured to be communicatively coupled to the data port and to a plurality of sub-systems on the vehicle, wherein the datalogger is further configured to receive corrective information via the data port and to affect a repair of the vehicle using the corrective information.

19. An apparatus as defined in claim 18, further comprising a user interface configured to communicate with the datalogger to enable a user to cause the datalogger to communicate with the non-volatile data storage device via the data port.

20. An apparatus as defined in claim 19, wherein the user interface comprises at least one of a light emissive device to provide a visual display for the user or an input device to configured to receive an input from the user.

21. An apparatus as defined in claim 19, wherein the user interface is configured to provide information associated with at least one of a maintenance notification, a fault condition, a request to communicate with the non-volatile data storage device via the data port, or a plurality of service tickets.

22. An apparatus as defined in claim 18, wherein the data port comprises a removable cover configured to substantially prevent the ingress of contaminants to the data port.

23. An apparatus as defined in claim 22, wherein the removable cover is configured to be screwed onto or snapped onto the data port.

24. An apparatus as defined in claim 18, wherein the data port is configured to receive a universal serial bus connector.

25. A datalogger, comprising:
a processor and a memory coupled to the processor, wherein the processor is programmed to:
receive corrective vehicle information from a non-volatile data storage device, wherein the non-volatile data storage device does not require an internal power source to perform storage operations; and
convey the corrective vehicle information to at least one sub-system of a vehicle to affect a repair of the vehicle.

26. A datalogger as defined in claim 25, wherein, in response to detection of a fault condition associated with the vehicle, the processor is programmed to generate a prompt signal associated with requesting the coupling of the non-volatile storage device to a data port on the vehicle.

27. A datalogger as defined in claim 25, wherein, in response to a user-initiated event, the processor is programmed to generate a prompt signal associated with requesting the coupling of the non-volatile data storage device to a data port on the vehicle.

28. A datalogger as defined in claim 25, wherein the processor is programmed to receive the corrective vehicle information via a universal serial bus.

29. A datalogger as defined in claim 25, wherein the processor is programmed to convey at least some of the corrective vehicle information to the at least one sub-system via a controller area network.

30. A datalogger as defined in claim 25, wherein the non-volatile data storage device is a memory stick and the processor is programmed to receive the corrective vehicle information via a data port configured to receive the memory stick.

31. A datalogger, comprising:
a data collector configured to collect information conveyed via a data bus associated with a plurality of sub-systems of a vehicle;
a time stamper configured to time stamp data collected by the data collector;
an event detector configured to identify events associated with the data bus and to identify at least a portion of the collected data associated with the events;
a memory configured to receive the collected data and event information;
a data input/output interface configured to receive corrective vehicle information; and
a sub-system interface configured to use at least a portion of the corrective vehicle information to convey information via the data bus to affect a repair of the vehicle.

32. A datalogger as defined in claim 31, wherein the memory is configured to store service ticket information associated with the vehicle.

33. A datalogger as defined in claim 31, further comprising a real-time clock to provide time information to the time stamper.

34. A datalogger as defined in claim 31, further comprising a notifier configured to convey at least one of maintenance messages or fault messages to a user interface.
